(19) United States
(12) Patent Application Publication
(10) Pub. No.: US 2007/0071547 A1
(43) Pub. Date: Mar. 29, 2007

(54) Tube with ball socket

(75) Inventor: Rafael Francisco Berrittella, Buenos Aires (AR)

Correspondence Address: VENABLE LLP, P.O. BOX 34385, WASHINGTON, DC, 20043-9998, US

(73) Assignee: GRAHAM PACKAGING COMPANY, L.P., York, PA (US)

(21) Appl. No.: 11/235,543

(22) Filed: Sep. 27, 2005

(51) Int. Cl. F16C 11/00

(52) U.S. Cl. 403/122

(57) ABSTRACT

An article for dispensing a substance can include a tube with a ball socket. The ball socket can be fluidly coupled to the interior of the tube.

### BACKGROUND OF THE INVENTION

1. Field of the Invention

The instant invention relates to a tube with a ball socket, which can be used for the storage, distribution, and dispensing of a substance. More particularly, the invention is a tube with a ball socket fluidly coupled to the interior of the tube.

2. Description of the Related Art

One type of a dispensing package which can be used to apply or dispense a substance is a roll-on dispenser. In a roll-on dispenser, the package terminates in a ball that is rotatably mounted into a socket at the end of the package. Substance on the inside of the package can be distributed onto the surface of the ball, for example, by inverting the package. The ball is then rolled over a surface on which the substance in the package is to be dispensed. The substance which is attached to the ball then adheres to the surface to which it is being applied.

A conventional roll-on dispenser is produced by forming a ball socket. A bottle or other container is separately formed. The ball socket is then coupled with the bottle. The bottle can be filled with a substance to be dispensed before the ball socket, into which a ball has been inserted, is coupled with the bottle. Or, the bottle can be filled with the substance after the ball socket has been coupled with the bottle, but before the ball has been inserted into the ball socket.

Injection molding can be an expensive way to manufacture a part in contrast with, for example, blow molding. In the traditional approach, separate steps are required to form the ball socket and the bottle and to couple these parts to each other. Production of an injection molded bottle of a different volumetric capacity for holding a substance, for example, to meet a changed market condition, requires the production of a new mold, which can be time-consuming and expensive. A bottle is heavier, i.e., requires more raw material to manufacture, than a comparable tube.

A conventional roll-on dispenser cannot be assembled until a commercial customer has filled the dispenser with substance, e.g., a personal care substance. That is, the commercial customer must couple the ball socket with the bottle or insert the ball into the ball socket after filling. A commercial customer may not have an appropriate filling line or be able to economically justify establishing or modifying a filling line for such an operation. This limits the range of dispenser systems a commercial customer can choose from, and limits the market for conventional roll-on dispensers.

A roll-on dispenser which has a bottle is limited in several respects, particularly when the bottle is rigid or only slightly flexible. For example, an individual consumer may not be able to force remaining substance out of the bottle by squeezing the container. The roll-on dispenser must be inverted during an application so that the substance flows to the ball under the influence of gravity; or, at least, the roll-on dispenser must be frequently inverted between applications to refresh the ball with substance from the bottle. The roll-on dispenser may be not be suitable for substances having a high viscosity, because it may take too long for a high-viscosity substance to flow to the ball when the dispenser is inverted for an application.

There thus remains a need for an article including a tube with a socket for accepting a ball applicator for dispensing a substance that can be inexpensively manufactured, that is light in weight, and for which production equipment can be quickly and inexpensively modified to vary the volumetric capacity of the article. The article is desirably able to be fully assembled by a manufacturer before shipment to a commercial customer for use in a packaging application. A commercial customer's filling line should be easily and inexpensively adaptable to use of the article. After filling, the article can maximize usage of the substance and can be used to dispense the substance when held in a wide range of orientations with respect to the local vector of gravitational acceleration, and can be used to dispense a wide range of substances, including high viscosity substances.

### SUMMARY OF THE INVENTION

It is therefore an object of the instant invention to provide articles including tubes with a ball socket for accepting a ball to form a roll-on dispenser for dispensing a substance. Such articles can be inexpensively manufactured and are light in weight; production equipment for filling the articles can be quickly and inexpensively modified to vary the volumetric capacity of the articles. The articles can be fully assembled by a manufacturer before shipment to a commercial customer for use in a packaging application, for which a commercial customer's filling line can be easily and inexpensively adapted. Articles according to the invention can maximize usage of the substance, can be used to dispense the substance when held in a wide range of orientations with respect to the local vector of gravitational acceleration, and can be used to dispense a wide range of substances, including high viscosity substances.

An embodiment of an article of the instant invention includes a ball socket and a tube having walls and an interior. The ball socket can be fluidly coupled to the interior of the tube. The ball socket and the tube can be mechanically connected, for example, through threads, snaps, or another mechanical connection system. Alternatively, the ball socket and the tube can be connected by gluing. Alternatively, the ball socket and the tube can be integral; for example, the ball socket and the tube can be molded as a single piece, or, for example, the ball socket and the tube can be physically joined by spin welding, thermal bonding, ultrasonic welding, or another technique for fusing two members. The ball socket and/or the tube can be formed by, for example, blow molding, injection molding, blow-injection molding, or extrusion-injection molding. For example, in blow-injection molding, the tube can be injection molded as a hollow cylinder, and then blown to form the final tube. In extrusion-injection molding, the ball socket can be injection molded, the tube can be extruded, and the ball socket can be thermally welded to the tube.

The ball socket can be blow molded and can include an open cylinder having a circumferential wall, a first retaining portion at a first edge of the circumferential wall and integral with the circumferential wall, and a second retaining portion at a second edge of the circumferential wall and integral with the circumferential wall. The tube can be blow molded. The ball socket can be integral with the walls of the tube. The tube can be squeezable and can have a sealed seam at an end of the blow molded tube opposite the ball socket.

A method for producing an article can include blow molding a ball socket onto a tube having walls and an interior, so that the ball socket is fluidly coupled to the interior of the tube. The tube can be open to the ball socket at a first end of the tube and the tube can be open to an environment at a second end of the tube.

A method of packaging a substance can include providing an article. The article can include a ball socket, with a ball captured within the ball socket. The ball socket can be fluidly coupled to an interior of a tube. The tube can have a first opening to the ball socket and can have a second opening. The method can include placing the ball socket, ball, and tube on a filling line, filling the tube with a substance through the second opening, and sealing the second opening in the tube.

### BRIEF DESCRIPTION OF THE DRAWINGS

FIG. 1 is an elevational view of an article according to an embodiment of the invention.

FIG. 2 is a perspective view of an open cylinder according to an embodiment of the invention.

FIG. 3 is a top plan view of an open cylinder according to an embodiment of the invention.

FIG. 4 is a cross-sectional view of an open cylinder according to an embodiment of the invention.

FIG. 5 is an elevational view of an article with a cap shown partially cut away according to an embodiment of the invention.

FIG. 6 is an elevational view of an intermediate article according to an embodiment of the invention with a moil.

FIG. 7 is an elevational view of another intermediate article according to an embodiment of the invention with no ball or cap.

FIG. 8 is a cross-sectional view of an article with a cap according to an embodiment of the invention.

FIG. 9 is a cut-away view of a cap according to an embodiment of the invention.

### DETAILED DESCRIPTION

Embodiments of the invention are discussed in detail below. In describing embodiments, specific terminology is employed for the sake of clarity. However, the invention is not intended to be limited to the specific terminology so selected. A person skilled in the relevant art will recognize that other equivalent components can be employed and other methods developed without parting from the spirit and scope of the invention. All references cited herein are incorporated by reference as if each had been individually incorporated.

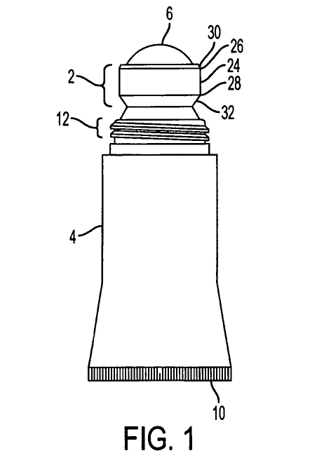

An embodiment of an article including a ball socket 2 and a tube 4 having walls and an interior is shown in FIG. 1. The ball socket 2 can be fluidly coupled to the interior of the tube 4. The ball socket 2 can be integral with the walls of the tube; for example, the ball socket 2 and the tube 4 can be molded as a single unit. The ball socket 2 can be formed of, for example, a thermoplastic, such as polyethylene, polypropylene, another polyolefin, polyethylene terephthalate, or another polymer. The tube 4 can be formed of, for example, a thermoplastic, such as polyethylene, polypropylene, another polyolefin, polyethylene terephthalate, or another polymer.

The ball socket 2 can be produced by blow molding or by another process. A ball socket 2 produced by blow molding can require less expensive tooling than, for example, a ball socket 2 produced by, for example, injection molding. Production of a ball socket 2 by blow molding can be less expensive than, for example, production of a ball socket 2 by injection molding.

When the ball socket 2 and the tube 4 are blow molded together in a single operation, a molding step can be eliminated, and manufacturing steps of assembling the ball socket 2 and the tube 4 can be eliminated. Extrusion blow molding, which is a known method for producing a tube shaped container, is amenable to producing an article according to the instant invention. Extrusion blow molding molds can be modified or formed to produce a ball socket 2 at a terminus of an existing tube design as set forth herein.

When the tube 4 is blow molded, for example, when the tube 4 is blow molded together with the ball socket 2 in a single operation, the blow molding process can be rapidly, easily, and inexpensively adapted to produce tubes 4 of different size. The same mold can be used to produce different sizes of tubes 4 by producing a tube that can be cut to various lengths in order to hold varying amounts of substance. Thus, articles including blow molded ball sockets 2 and blow molded tubes 4 according to the instant invention can be rapidly, easily, and inexpensively altered to be able to contain more or less of a substance, such as a consumer substance, to provide variety to the consumer or to suit changing market conditions. By contrast, when a tube or a bottle is produced by injection molding, a different mold must be used for each tube or bottle produced.

An article according to the instant invention which includes a ball socket 2 and a tube 4 can be made to weigh less than a conventional roll-on dispenser that includes a bottle, rather than a tube. The reduction in weight afforded by such an embodiment of the instant invention can reduce raw material costs and transportation costs.

An article including a tube 4 and a ball socket 2 according to the instant invention provides another choice to a producer of a substance for storing, packaging, and dispensing a substance in addition to conventional packaging systems. Furthermore, an article according to the instant invention can afford advantages over a conventional tube dispenser which does not include a ball socket. For example, an article according to the instant invention including a ball socket 2 can dispense a substance in a more controlled manner than can a tube without a ball socket, and avoid, for example, the uncontrolled and undesired release of a large amount of substance. An article according to the instant invention, which includes a ball socket 2, can be used to dispense a wider range of substances than a tube without a ball socket. For example, an article according to the instant invention can be used to dispense low viscosity liquids, which would run too quickly out of a tube without a ball socket and ball. The ball socket 2 of an article according to the instant invention can be used by an individual consumer to dispense the substance evenly over a surface, which saves the individual consumer an additional step of distributing the substance, for example, rubbing.

The tube 4 can include information in the form of, for example, text or pictures printed directly on the tube 4, or in the form of, for example, text or pictures printed on a label applied to the tube 4. The tube 4 and/or the ball socket 2 can be formed of a transparent material, for example, a transparent thermoplastic. A transparent tube can have advantages; for example, a consumer can see a color of a substance or the substance's level inside the tube. A double-face label can be applied to the transparent tube, so that a consumer can read the reverse side of the label through the tube as well as read the obverse side of the label.

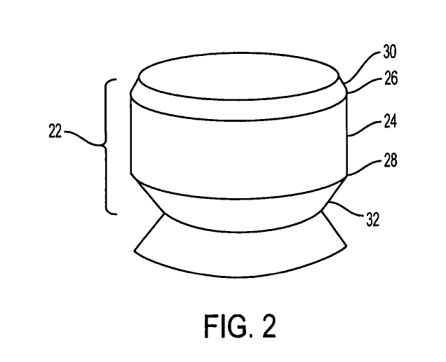

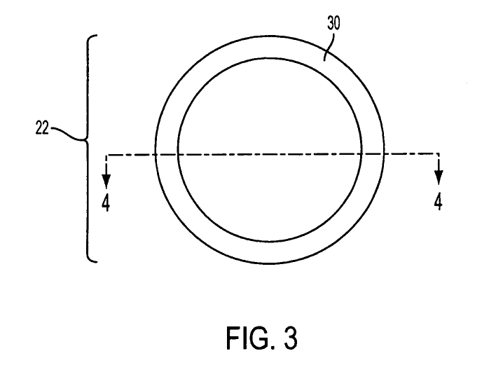

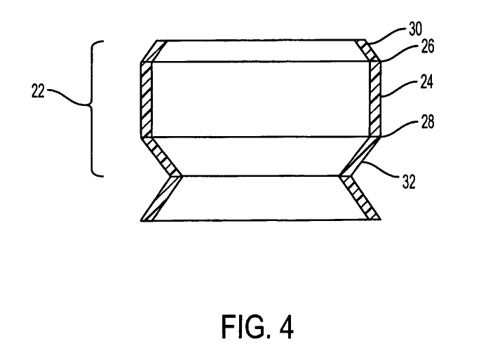

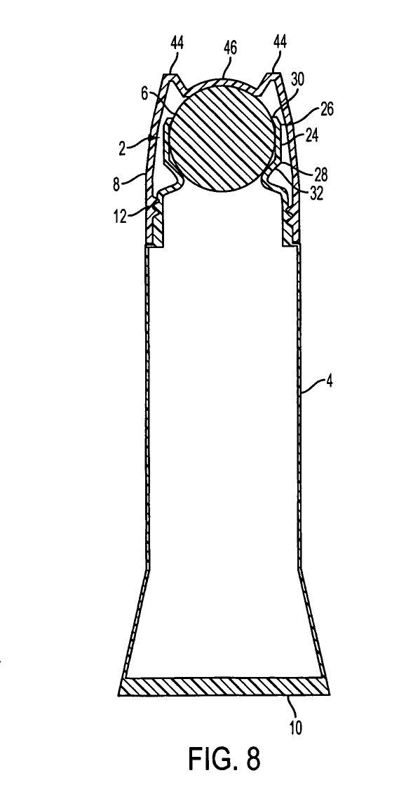

The ball socket 2 can include an open cylinder 22 as shown in FIGS. 2-4. The open cylinder 22 can include a circumferential wall 24, a first retaining portion 30 at a first edge 26 of the circumferential wall 24, and a second retaining portion 32 at a second edge 28 of the circumferential wall 24; these features are illustrated in FIGS. 1-8. The first retaining portion 30 and second retaining portion 32 are positioned and dimensioned to hold a ball 6 in the ball socket 2, in a similar manner as conventional roll-on dispensers. For example, FIG. 1 shows that the second retaining portion 32 is adjacent to the tube 4, the circumferential wall 24 is adjacent to the second retaining portion 32, and the first retaining portion 30 is adjacent to the circumferential wall 24. FIG. 8 shows a ball 6 as being retained between the first retaining portion 30 and the second retaining portion 32. FIG. 3 illustrates a top view of the open cylinder 22, in which the first retaining portion 30 is visible. FIG. 4 illustrates a cross-section taken along line 4-4 of FIG. 3 of the open cylinder 22. The first retaining portion 30, the first edge 26, the circumferential wall 24, the second edge 28, and the second retaining portion 32 can be seen. The first retaining portion 30 can be integral with the circumferential wall 24; for example, the first retaining portion 30 and the circumferential wall 24 can be blow molded as one unit. The second retaining portion 32 can be integral with the circumferential wall 24; for example, the second retaining portion 32 and the circumferential wall 24 can be blow molded as one unit.

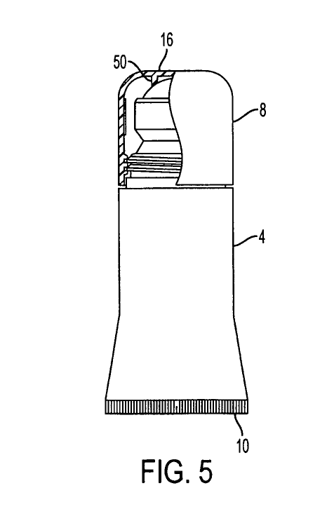

The article can include a ball 6 captured within the ball socket 2, so that the ball 6 can rotate within the ball socket 2, as shown in FIGS. 1 and 8. The ball 6 can be formed of, for example, a thermoplastic, such as polyethylene, polypropylene, another polyolefin, polyethylene terephthalate, or another polymer. The article can include a cap 8, as shown in FIG. 5. The cap 8 can be formed of, for example, a thermoplastic, such as polyethylene, polypropylene, another polyolefin, polyethylene terephthalate, or another polymer. The cap 8 can be removably affixed to the tube 4 and can cover the ball socket 2. The tube 4 can, for example, include threads 12, shown in FIGS. 1 and 5-8, and the cap 8 can have matching threads, so that the cap 8 can be screwed onto the tube 4, as shown in FIGS. 5 and 8. As another example, the tube 4 can have a snap feature, and the cap 8 can have a mating snap feature, so that the cap 8 can be snapped onto the tube 4. Other systems for removably affixing the cap 8 to the tube 4 can be used.

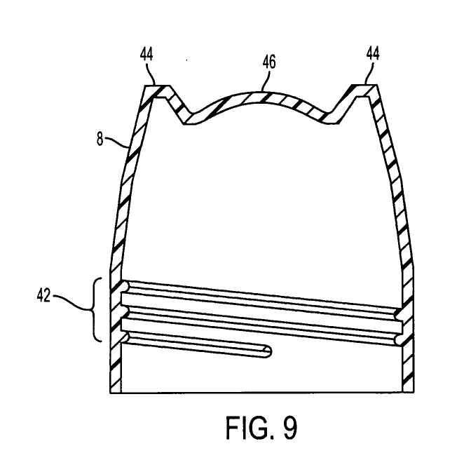

FIG. 8 presents a cross-sectional side view of an embodiment of the article with the tube 4, ball socket 2, ball 6, and cap 8. The cap 8 is shown as screwed onto the tube 4 in FIG. 8. A cut-away side view of an embodiment of the cap 8 is shown in FIG. 9. The threads 42 of the cap 8, which can mate to the threads 12 on the tube 4, are shown. The cap 8 includes a standing ring 44, which projects upward above the rest of the cap 8, and includes a cradle feature, for example, the semi-spherical cradle feature 46 shown, into which a ball 6 can fit.

An article including a cap 8, such as that shown in FIGS. 8 and 9, can be stored with a standing ring 44 of the cap 8 resting on a surface. Storing the article with the cap 8 supporting the remainder of the article on a surface, so that the portion of the surface of the ball 6 facing the tube 4 is in contact with a substance in the interior of the tube 4, allows the substance to be immediately applied by rolling the ball 6. Similarly, an article including a cap 8 which has a flat region 16 on the side of the cap 8 opposite the tube 4, such as shown in FIG. 5, can be stored with the flat region 16 of the cap 8 resting on a surface and supporting the remainder of the article. A cap 8 with a flat region 16 can also include a cradle feature; for example, a short hollow cylinder 50, partially shown in FIG. 5, which can project from the inner surface of the flat region 16 and can contact the ball 6, can serve as a cradle feature.

The tube 4 can be a blow molded tube. The tube 4 can be squeezable. For example, the walls of the tube 4 can be soft and flexible, so that the tube can be readily deformed. An article according to the instant invention that includes a squeezable tube 4 has several advantages over a conventional roll-on dispenser which has a more rigid bottle. For example, an individual consumer can expel more substance from an article according to the instant invention with a squeezable tube 4, ball socket 2, and ball 6 than from a conventional roll-on dispenser which has a more rigid bottle. An article according to the instant invention that includes a squeezable tube 4 can be used to dispense substances of high viscosity. An article according to the instant invention that includes a squeezable tube 4 can be used to dispense a substance without the assistance of gravity, e.g., without the ball 6 being at the lowest point of the article. For example, a substance can be dispensed with the article held in a wide range of orientations with respect to the local gravitational acceleration vector.

The article can include a sealed seam 10 at an end of the tube 4 opposite the ball socket 2, as illustrated in FIGS. 1, 5, and 8. The article can include a sealed seam 10 at any position on the tube 4.

A method for producing an article can include placing a ball socket 2 onto a tube 4, the tube 4 having walls and an interior, so that the ball socket 2 is fluidly coupled to the interior of the tube 4. The tube 4 can be open to the ball socket 2 at a first end of the tube 4, and the tube 4 can be open to an environment at a second end of the tube 4. For example, the ball socket 2 can be blow molded onto the tube 4. For example, the ball socket 2 and the tube 4 can be blow molded together in a single operation. The blow molded ball socket 2 can, for example, be blow molded from the end section of the tube 4 that is adjacent to the first end of the tube 4. Alternatively, the ball socket 2 can be blow molded onto a pre-existing tube 4.

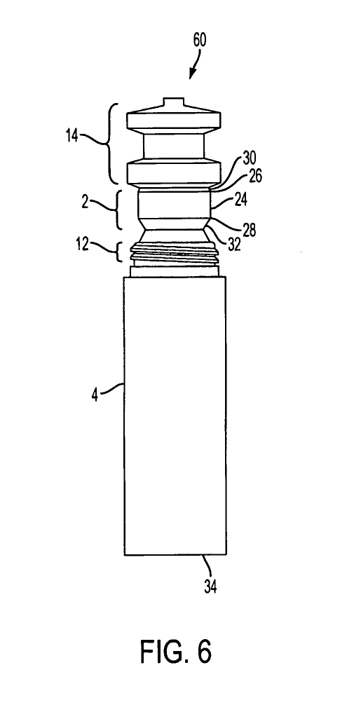

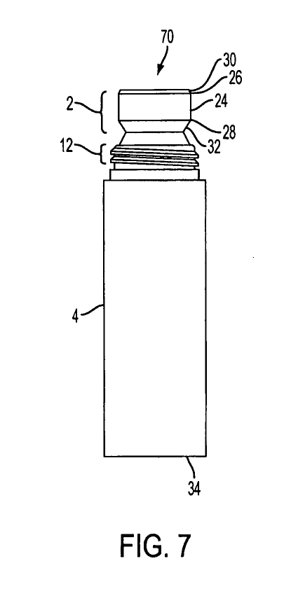

When the ball socket 2 and/or the tube 4 are blow molded, for example, blow molded together in a single operation, a moil, for example, a portion of excess material, can be formed. For example, an intermediate article 60 according to the invention can have, after blow molding, a moil 14 formed on an end of the ball socket 2, as illustrated in FIG. 6. Such an intermediate article can have an open end 34. The moil 14 can be trimmed away, for example, trimmed away from the ball socket 2 or the tube 4, to leave the ball socket 2 and tube 4 to form another intermediate article 70, as illustrated in FIG. 7.

FIG. 7 also presents an intermediate article 70, after formation by a process that does not leave a moil. For example, injection molding, blow injection molding, and extrusion-injection molding can be conducted so as not to leave a moil on the article.

Blow molding the ball socket 2 and the tube 4 together in a single operation has the advantage that there is no potential substance loss region between the ball socket 2 and the tube 4. Thus, after an article according to the present invention, including a ball 6 and a ball socket 2 and a tube 4 formed together, with substance in the tube 4, and with any opening in the tube 4 other than the opening to the ball socket 2 sealed is manufactured, the only substance loss region is between the ball socket 2 and the ball 6. By contrast, when a ball socket 2 is conventionally mechanically connected to a bottle, substance loss can occur in the region between the ball socket 2 and the bottle as well as between the ball socket 2 and a ball 6.

The ball socket 2 and the tube 4 can also be extrusion-injection molded. For example, the ball socket 2 can be injection molded, the tube 4 can be extruded, and the ball socket 2 and the tube 4 can be thermally welded.

A method according to the invention can include placing a ball 6 into the ball socket 2, so that the ball 6 is rotatably captured within the ball socket 2; that is, so that the ball 6 can rotate within the ball socket 2. For example, the ball 6 can be placed into the ball socket 2 of a ball socket 2 and tube 4 that have been blow molded together in a single operation.

A method can also include placing a cap 8 over the ball socket 2. The cap 8 can be removably affixed to the tube 4. For example, the cap 8 can be screwed onto the tube 4, the cap 8 can be snapped onto the tube 4, or the cap 8 can be otherwise removably affixed to the tube 4.

A method can include filling the interior of the tube 4 with a substance. For example, the tube 4 can be filled through an opening into the tube 4 other than an opening of the tube 4 to the ball socket 2, as is common with conventional tubes. For example, the tube 4 can be filled through an opening into a side of the tube 4. As another example, the tube 4 can be filled through an opening at an end of the tube 4 opposite the ball socket 2, for example, an opening in the second end of the tube 4 opposite the ball socket 2, as is conventionally known for the filling of tubes. For example, the tube 4 can be filled through an opening at an end of the tube 4 which is geometrically opposite with respect to and faces the end of the tube 4 which is coupled to the ball socket 2. As another example, the tube 4 can be filled through an opening at an end of the tube 4 which is at a complementary opposite of the end of the tube 4 which is coupled to the ball socket 2. For example, a curved tube 4 can be filled through an opening in the curved tube's terminus to which the ball socket 2 is not coupled.

The substance filled into the tube, which can be dispensed using the roll-on applicator can include, for example, a liquid, a gel, a suspension, a powder, or any combination of these. The substance can be, for example, a stain remover product, an analgesic or pain killing gel, a personal care substance, such as a deodorant or antiperspirant, a sun protection agent, or a cosmetic agent.

The tube 4 can be sealed so that the tube interior is bounded by the ball socket 2 and the walls of the tube 4. Sealing can include, for example, fusing edges of an opening at an end of the tube 4 opposite the ball socket 2 together with heat to create a sealed seam 10. For example, sealing can include gluing edges of an opening at an end of the tube 4 opposite the ball socket 2 together to create a sealed seam 10. For example, sealing can include crimping the edges of an opening of the tube 4 at an end of the tube 4 opposite the ball socket 2 together to form a sealed seam 10.

A method can include blow molding, for example, extrusion blow molding, a ball socket 2 and a tube 4 with a moil 14 in a single operation to form an intermediate article 60, as shown in FIG. 6. After forming, the moil can be trimmed away above the first retaining portion 30 to provide a second intermediate article 70, as shown in FIG. 7. The intermediate article 70 can include an open end 34. After formation of this intermediate article, the open end of the tube 4 can be trimmed. By trimming the tube 4 to various lengths, differently sized tubes 4 can be manufactured. Thus, the invention is readily modifiable to produce tubes 4 of different sizes. Because the subsequent steps involve a typical mechanism for filling a tube 4, there is no need for major modifications in the equipment to either manufacture tubes 4 of different sizes, or to process, i.e., fill, differently sized tubes 4. As described more fully below, a ball 6 can be placed in the ball socket 2 while the end 34 remains open. This effectively seals the one end of the tube 4 and allows for processing in a conventional manner. In particular, the tube 4 can be inverted so that the open end 34 faces upward. A substance can then be filled into the tube 4 and the open end 34 of the tube 4 crimped and sealed to form a seam 10 as is known in the art. As also described below, the cap 8 can be placed upon the article either before or subsequent to filling with a substance. Placement of the cap 8 on the article prior to filling has the advantage of providing a surface upon which the tube 4 can rest in an inverted position as it is being processed.

The ability to fill the tube 4 through a second opening, the second opening being in addition to the first opening of the tube 4 to the ball socket 2, allows for flexibility in a packaging process. For example, the article can be manufactured with the ball socket 2 fluidly coupled to the interior of the tube 4. A ball 6 can be captured within the ball socket 2, for example, the ball 6 can be inserted into the ball socket 2. The tube 4 can have a first opening to the ball socket 2 and can have a second opening. This article according to the instant invention can be provided before shipping the article to a commercial customer. The commercial customer, for example, a producer of personal care substances, can then, for example, place the article including the ball socket 2, ball 6, and tube 4 on a filling line. For example, the commercial customer can receive the article with a cap 8 removably affixed to the tube 4 and over the ball socket 2, and the commercial customer can place the article, so that it is supported by its cap 8 on the filling line and the second opening in the tube 4 points upward. As another example, the commercial customer can receive the article without a cap 8, and the commercial customer can position the ball socket 2 of an article according to the instant invention in a bin socket to hold the article on the filling line. The commercial customer can also hold the article on the filling line in another way. The commercial customer can fill the substance into the tube 4 through the second opening. The commercial customer can then seal the second opening, for example, to complete the packaging of the substance.

It can be advantageous, for example, convenient in terms of inventorying and/or cost efficient, for a commercial customer to buy an article including a ball socket 2, ball 6, tube 4, and cap 8 from a single supplier, rather than buying, for example, ball socket 2 and tube 4 assemblies from one supplier, buying balls 6 from another supplier, buying caps 8 from yet another supplier, and storing the assemblies, balls, and cap separately until the assembly is filled with substance and the ball 6 and cap 8 are placed onto the assembly.

The actions of placing the article on a filling line, filling the tube 4, and sealing the second opening of the tube 4 can be carried out in the same, or nearly the same manner as for filling any tube not fluidly coupled with a ball socket 2. The actions can be carried out with the same, or nearly the same equipment as used for filling any tube not fluidly coupled with a ball socket 2. This represents an advantage for commercial customers who already have established tube filling lines. These commercial customers can use their established filling lines, or can use their established filling lines after only minor modification, to package a substance into an article according to the instant invention including a ball socket 2 and tube 4. For example, the article including the tube 4, the ball socket 2, the ball 6, and the cap 8 can be placed with its cap 8 down on the filling line, the tube 4 can be filled through an opening in the tube 4 opposite the cap 8, and the opening opposite the cap 8 can be sealed, just as for a conventional tube without a ball socket 2. The tube 4 of the article can be decorated, for example, written or pictorial information can be printed on the tube 4 or included on a label which is affixed to the tube 4 prior to filling. Thus, after the tube 4 of an article according to the instant invention is filled and sealed, it can be immediately distributed and sold to consumers.

An article can include the following. A blow molded ball socket 2 can include an open cylinder 22 having a circumferential wall 24, a first retaining portion 30 at a first edge 26 of the circumferential wall 24, and a second retaining portion 32 at a second edge 28 of the circumferential wall 24. The first retaining portion 30 can be integral with the circumferential wall 24; the second retaining portion 32 can be integral with the circumferential wall 24. A blow molded tube can have walls and an interior. The blow molded ball socket 2 can be fluidly coupled to the interior of the blow molded tube, and the blow molded ball socket 2 can be integral with the walls of the blow molded tube. The blow molded tube can be squeezable, and can have a sealed seam 10 at an end of the blow molded tube opposite the blow molded ball socket 2.

The embodiments illustrated and discussed in this specification are intended only to teach those skilled in the art the best way known to the inventors to make and use the invention. Nothing in this specification should be considered as limiting the scope of the instant invention. All examples presented are representative and non-limiting. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

1. (canceled)

2. An article, comprising:
a ball socket; and
a tube having walls and an interior,
wherein the ball socket is fluidly coupled to the interior of the tube,
wherein the tube has a first end adjacent to the ball socket and has a second end, and
wherein the tube is open to the ball socket at the first end and open to an environment at the second end.

3. The article of claim 2, wherein the ball socket comprises an open cylinder having a circumferential wall and a first retaining portion at a first edge of the circumferential wall and a second retaining portion at a second edge of the circumferential wall.

4. The article of claim 3, wherein the first retaining portion is integral with the circumferential wall, and the second retaining portion is integral with the circumferential wall.

5. The article of claim 2, further comprising a ball captured within the ball socket, wherein the ball can rotate within the ball socket.

6. The article of claim 2, further comprising a cap, wherein the cap is removably affixed to the tube and covers the ball socket.

7. The article of claim 6, wherein the cap has a standing ring and a cradle feature.

8. The article of claim 2, wherein the tube is a blow molded tube.

9. The article of claim 2, wherein the tube is squeezable.

10. The article of claim 2, wherein the ball socket is integral with the walls of the tube.

11. (canceled)

12. An article, comprising:
a ball socket, and
a tube having walls and an interior,
wherein the ball socket is fluidly coupled to the interior of the tube,
wherein the tube has an end opposite the ball socket,
wherein the tube comprises a flattened sealed seam at the end of the tube opposite the ball socket.

13. The article of claim 12,
wherein the ball socket comprises an open cylinder having a circumferential wall, a first retaining portion at a first edge of the circumferential wall and integral with the circumferential wall, and a second retaining portion at a second edge of the circumferential wall and integral with the circumferential wall,
wherein the ball socket is integral with the walls of the tube,
and
wherein the tube is squeezable.

14. A method for producing an article, comprising:
placing a ball socket onto a tube having walls and an interior, so that the ball socket is fluidly coupled to the interior of the tube,
wherein the tube is open to the ball socket at a first end of the tube and the tube is open to an environment at a second end of the tube.

15. The method of claim 14, further comprising trimming a moil from the ball socket or from the tube.

16. The method of claim 14, further comprising placing a ball into the ball socket, so that the ball is rotatably captured within the ball socket.

17. The method of claim 14, further comprising placing a cap over the ball socket.

18. The method of claim 14, further comprising filling the interior of the tube with a substance.

19. The method of claim 18, wherein the interior of the tube is filled through an opening in the second end of the tube opposite the ball socket.

20. The method of claim 18, wherein the substance is at least one substance selected from the group consisting of a liquid, a gel, a suspension, and a powder.

21. The method of claim 14, wherein the ball socket is blow molded onto the tube.

22. The method of claim 21, wherein the blow molded ball socket is blow molded from the end section of the tube adjacent to the first end of the tube.

23. The method of claim 21, wherein the blow molded ball socket and the tube are blow molded in a single operation.

24. The method of claim 14, wherein the ball socket and tube are extrusion-injection molded.

25. The method of claim 14, further comprising sealing the tube so that the tube interior is bounded by the ball socket and the walls of the tube.

26. A method of packaging a substance, comprising:
providing a ball socket, having a ball captured within the ball socket, the ball socket fluidly coupled to an interior of a tube, the tube having a first opening to the ball socket and having a second opening;
placing the ball socket, ball, and tube on a filling line;
filling the tube with a substance through the second opening; and
sealing the second opening in the tube.
